(19) United States
(12) Patent Application Publication
(10) Pub. No.: US 2023/0155165 A1
(43) Pub. Date: May 18, 2023

(54) LITHIUM ION SECONDARY BATTERY

(71) Applicant: NEC CORPORATION, Tokyo (JP)

(72) Inventors: Kazuhiko INOUE, Tokyo (JP); Noboru YOSHIDA, Tokyo (JP); Kenichi SHIMURA, Tokyo (JP)

(73) Assignee: NEC CORPORATION, Tokyo (JP)

(21) Appl. No.: 18/156,740

(22) Filed: Jan. 19, 2023

Related U.S. Application Data
(63) Continuation of application No. 15/743,903, filed on Jan. 11, 2018.

(30) Foreign Application Priority Data
Jul. 28, 2015 (JP) 2015-149050

(51) Int. Cl. H01M 10/0525; H01M 10/0585; H01M 4/13; H01M 10/42; H01M 10/04; H01M 4/62; H01M 50/44; H01M 50/429; H01M 50/423; H01M 50/414

(52) U.S. Cl. CPC H01M 10/0525; H01M 10/0585; H01M 4/13; H01M 10/4235; H01M 10/0463; H01M 4/62; H01M 50/44; H01M 50/4295; H01M 50/423; H01M 50/414; H01M 4/623; H01M 4/485

(57) ABSTRACT

The lithium ion secondary battery is a secondary battery in which a positive electrode 30 and a negative electrode 40 are stacked alternatively via a separator 25, wherein the separator 25 is a single layer and is not melted or softened at least 200° C., a thermal shrinkage ratio of the separator being 3% or below, wherein an insulating layer 70 is formed on a surface of the positive electrode 30, the surface facing to the separator 25.

### CROSS REFERENCE TO RELATED APPLICATIONS

This application is a Continuation of U.S. application Ser. No. 15/743,903, filed on Jan. 11, 2018, which is a National Stage of International Application No. PCT/JP2016/071965, filed on Jul. 27, 2016, which claims priority from Japanese Patent Application No. 2015-149050, filed on Jul. 28, 2015, the contents of all of which are incorporated herein by reference in their respective entireties.

### TECHNICAL FIELD

The present invention relates to a secondary battery, particularly to a highly safe and high-energy-density lithium ion secondary battery in which a problem that safety of lithium battery could be impaired due to internal short circuit or the like caused by oxidization and deterioration of a high heat-resistant separator by a high potential positive electrode can be solved.

### BACKGROUND ART

Lithium ion secondary batteries are characterized by their small size and large capacity. Therefore, it has been widely used as a power source for electronic devices such as mobile phones and notebook computers, and has contributed to improvement of convenience of portable IT equipment. In recent years, attention has also been drawn to the use in large-sized applications such as power supplies for driving motorcycles or automobiles and storage batteries for smart grids. Demand for lithium ion secondary batteries has increased and they are being used in various fields. Along with that, it is becoming increasingly required to have functions such as further increase in energy density of batteries, lifetime performance to withstand long-term use, and ability of use under a wide range of temperature conditions.

To increase energy density and capacity of the battery, it is preferable to use a compound having high discharge capacity for positive electrode active material. In recent years, lithium nickel composite oxide, that a part of Ni of nickel lithium nickel (LiNiO₂) is substituted with another metal element, is widely used as a high capacity compound. In particular, one having a high Ni content is preferable since it has a high-capacity.

Patent Document 1 discloses a battery having a positive electrode including a lithium nickel composite oxide with high Ni content as a positive electrode active material, and a negative electrode formed by using a carbon material as a negative electrode active material and aqueous polymer as a binder. With such a configuration, it is possible to provide a lithium ion secondary battery having high-capacity and high cycle characteristics.

On the other hand, with respect to batteries with high energy density, when a failure of self-discharge due to internal short circuit occurs, heating amount is large and rate of temperature rise is fast. Therefore, the temperature inside the battery tends to be high. When a separator with low heat resistance is used, since it contains materials with a high thermal shrinkage ratio and a low melting point, separator is likely to be deformed or melted by exposure to high temperature. In this case, the separator cannot maintain its function, causing further short circuit.

To avoid this, heat-resistant separators with high heat-resistant temperature, using polyamide and polyimide and the like have also been developed. For example, Patent Document 2 discloses a porous polymer film for a battery separator using polyamide or polyimide whose porosity size, porosity rate and thickness are predetermined. Patent Document 3 describes a wholly aromatic polyamide microporous film with excellent heat resistance and mechanical strength suitable for a battery separator.

### PRIOR ART DOCUMENT

### Patent Document

Patent Document 1: Japanese Patent Application Laid-Open No. 2000-191823

Patent Document 2: Japanese Patent Application Laid-Open No. 1999-250890

Patent Document 3: Japanese Patent Application Laid-Open No. 2000-191823

### SUMMARY OF INVENTION

### Technical Problem

Highly heat-resistant separator is excellent material for keeping safety of lithium ion batteries even when exposed to high temperature. However, when a protection circuit breaks down and an overcharged state is generated, it may be oxidized and deteriorated. Especially in polyimide resin and aramid resin, HOMO obtained by molecular orbital calculation is higher than polyolefin, and therefore it is predicted that oxidation and deterioration are likely to occur when exposed to high electric potential.

Accordingly, the objective of the present invention is to provide a highly safe lithium ion secondary battery having high energy density, which can solve a problem that safety of the lithium battery is impaired due to internal short circuit as a result that highly heat-resistant separator is oxidized and deteriorated by high-potential positive electrode.

### Solution to Problem

To achieve the above object, a battery according to one embodiment of the present invention is as follows:

A lithium ion secondary battery in which a positive electrode and a negative electrode are stacked alternatively via a separator,

wherein the separator is a single layer and is not melted or softened at at least 200° C., a thermal shrinkage ratio of the separator being 3% or below,

wherein an insulating layer is formed on a surface of the positive electrode, the surface facing to the separator.

### ADVANTAGEOUS EFFECT OF INVENTION

According to the present invention, a highly safe lithium ion secondary battery having high energy density can be provided, which can solve a problem that safety of the lithium battery is impaired due to internal short circuit as a result that highly heat-resistant separator is oxidized and deteriorated by high-potential positive electrode.

### BRIEF DESCRIPTION OF DRAWINGS

FIG. 1 is a perspective view showing a basic structure of a film-packaged battery.

FIG. 2 is an exploded perspective view showing a basic structure of a film-packaged battery.

FIG. 3 is a cross-sectional view schematically showing a cross section of the battery of FIG. 1.

FIG. 4 is a cross-sectional view schematically showing a structure of a stacked assembly of battery elements according to the example of the present invention.

FIG. 5 is a cross-sectional view schematically showing a structure of a stacked assembly of battery elements according to another example of the present invention.

FIG. 6 is a schematic view showing procedure of manufacturing electrode (coating).

FIG. 7 is a schematic view showing procedure of manufacturing electrode (slit).

FIG. 8 is a schematic view showing procedure of manufacturing electrode (punching).

### DESCRIPTION OF EMBODIMENTS

### 1. Basic Configuration Of Film Packaged Battery

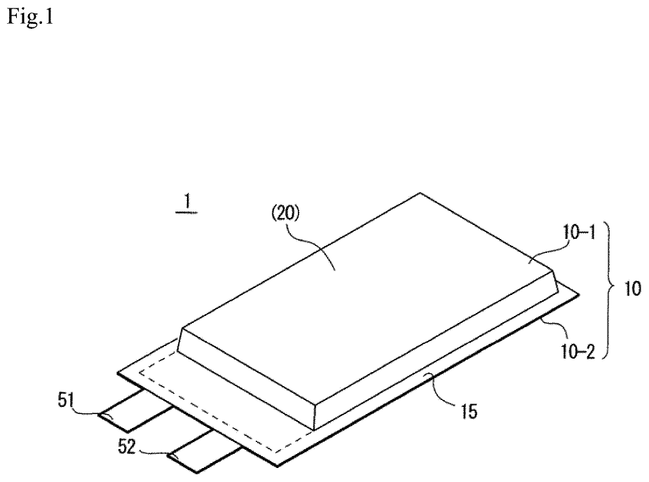

A basic configuration of a film packaged battery will be described with reference to FIGS. 1 to 3. Here, a film packaged battery where a battery element is stacked type will be described as an example.

A film packaged battery 1 according to an embodiment of the present invention has a battery element 20, a film package 10 for accommodating the battery element 20 together with electrolyte, a positive electrode tab 51 and a negative electrode tab 52 (also simply referred to as “electrode tab” below).

The Battery element 20 is a stacked structure in which a plurality of positive electrodes 30 and a plurality of negative electrodes are stacked alternatively with inserting separators 25 therebetween. With respect to the positive electrode 30, electrode materials 32 have been applied to both surfaces of a metal foil 31. Similarly, with respect to the negative electrode 40, electrode materials 42 have been applied to both surfaces of a metal foil 41. Entire shape of the battery element 20 is, but not limited to, a substantially flat rectangular parallelepiped shape in this example.

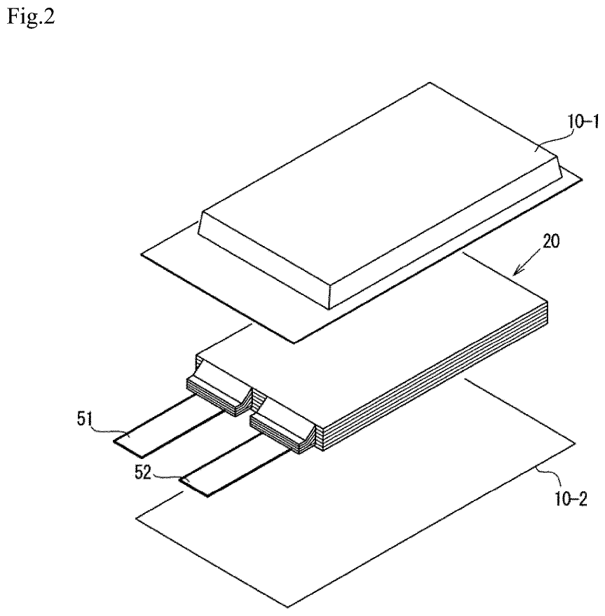

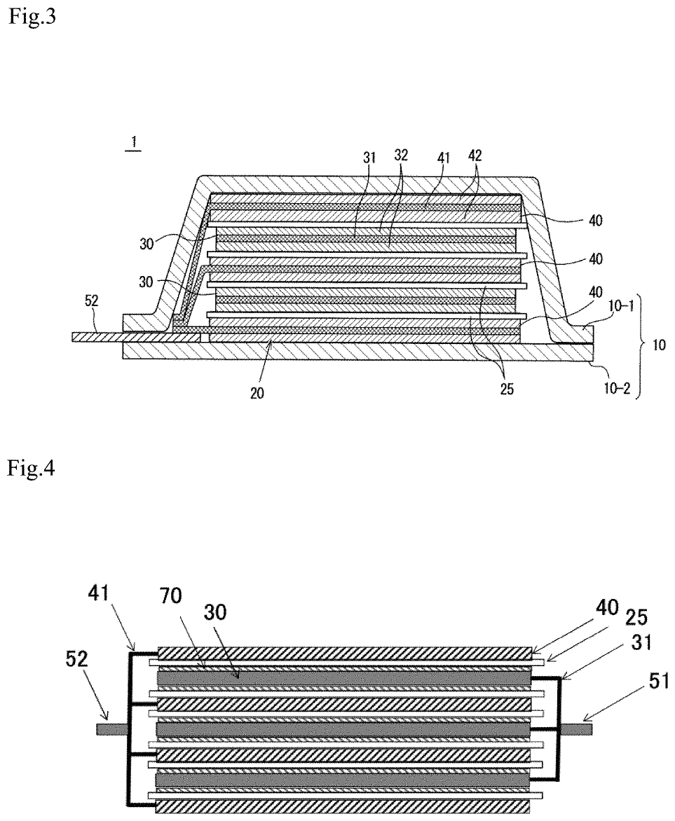

The positive electrode 30 and negative electrode 40 have extending portions protruding partially at a part of their peripheral portion, respectively. The extending portions of the positive and negative electrodes 30 and 40 are disposed alternatively, so that they do not interfere with each other when the electrodes are stacked. All of the negative extending portions are gathered and connected to the negative electrode tab 52 (FIG. 2 and FIG. 3). Similarly, with respect to the positive electrodes, all of the positive electrodes are gathered and connected to the positive electrode tab 51.

It is noted that such portions that the extending portions have been gathered along a stacking direction may be referred to as “current collector”, for example. For connecting the electrode tab to the collector, resistance welding, ultrasonic welding, laser welding, caulking, adhesion with a conductive adhesive, or the like can be used.

Various materials can be used for the electrode tab, however, the positive electrode tab 51 is made of aluminum or an aluminum alloy, whereas the negative electrode tab 52 is made of copper or nickel, for example. If material of the negative electrode 52 is copper, nickel may be disposed on the surface. The electrode tabs 51 and 52 are electrically connected to the battery element 20 and extended to the outside of the film package 10.

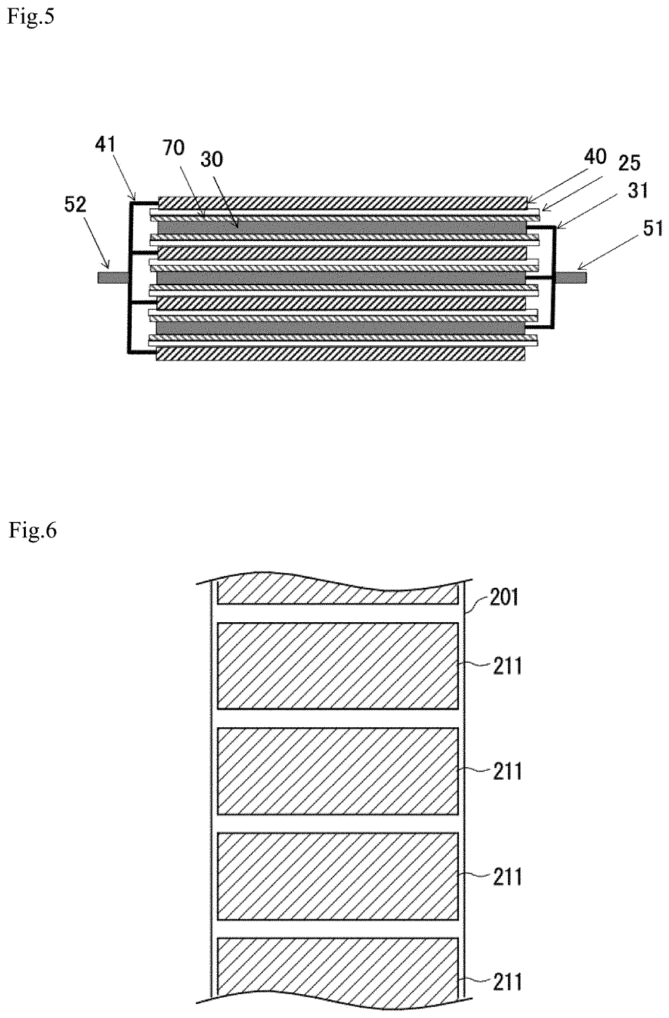

FIG. 4 and FIG. 5 are sectional views which schematically show a configuration of the stacked assembly. As described above, the positive electrodes 30 and negative electrodes 40 are stacked alternatively with inserting separators 25 therebetween. Portions of character 31 protruding from each positive electrode 31 are positive collector, and portions of character 41 protruding from each negative electrode 41 are negative collector. In this example, the positive electrode 51 is drawn out from one side of the battery, whereas the negative electrode 52 is drawn out from the opposite side thereof.

In the battery element of one embodiment of the present invention, insulating layer 70 is provided between the positive electrode 30 and the separator 25. FIG. 3 shows an example in which the insulating layer 70 is formed on the separator 25.

### 2. Configuration of Each Component

For an embodiment of the present invention, each components of the lithium ion secondary battery will be described.

[Separator]

In one embodiment of the present invention, thermal shrinkage ratio of the separator in electrolyte solution at its boiling point is less than 3%. Shrinkage ratio of the separator at the boiling point in the electrolyte solution can be measured by a thermal mechanical analysis (TMA). Since it is difficult to accurately measure a shrinkage ratio especially at the melting point of the separator or its approximation range due to the load applied to the separator, it is measured by the following method, for example. That is, in one example, a positive electrode (e.g. 120 mm×120 mm), a separator (e.g. 100 mm×100 mm), and a negative electrode (e.g. 120 mm×120 mm), stacked in this order, are disposed between two glass plates (e.g. 150 mm×150 mm×5 mm). After leaving it in an oven for one hour that has been adjusted to at boiling point of the electrolyte solution, thermal shrinkage ratio is measured.

Thermal shrinkage ratio (S) is a percentage of a longitudinal directional or the lateral directional dimensional change (L₀−L) with respect to the initial value (L₀) and the value can be calculated as follows:

S=(L₀−L)/L₀×100

With respect to insulating property of the separator, thickness of the separator is measured by using a separator heated to 400° C. The thickness is regarded as an indicator of the insulating property under high temperature. That is, thickness (Ts) of the insulating layer at 400° C. can be calculated by using a positive electrode thickness (Tc), a negative electrode thickness (Ta), and a total thickness (T):

Ts=T−Ta−Tc

When a negative electrode deteriorates and the lithium receivable amount of the negative electrode becomes smaller than the amount of lithium that can be released from the positive electrode, insulating property of the separator is lowered due to lithium deposition, and occurrence possibility of minor short circuit is increased. Even with a minor short circuit, the inside of the battery generates heat, but even in that case, entire short circuit can be prevented for the following reason. That is, according to the configuration in which the melting point of the separator is higher than the boiling point of the electrolyte solution and the thermal shrinkage ratio in the electrolyte solution at its boiling point is less than 3%, separator does not melt or deform and the function of preventing contact between a positive electrode and a negative electrode can be maintained.

If the separator shrinks and an entire short circuit occurs after the positive electrode and the negative electrode are brought into contact with each other, thermal runaway of the battery could be caused. Particularly, in a battery with a high energy density including positive electrodes with a charge capacity per unit area of 3 mAh/cm² or more, lithium deposition is likely to occur and there is a high risk of heat generation due to minor short circuit. If the electrolyte solution is completely evaporated by the heat and discharged to the outside of the battery, the battery loses its function.

However, by setting thermal shrinkage ratio of the separator in electrolyte solution to less than 3% at its boiling point, risk of direct contact between the electrodes can be avoided. Therefore, safety of the secondary battery can be maintained.

When chemical reaction between electrolyte solution and negative electrode or positive electrode is caused by heat due to short circuit, heating amount increases and temperature inside the battery could locally exceeds the boiling point of the electrolyte solution. Therefore, it is more preferable that the separator has a thermal shrinkage ratio of less than 3% at 200° C. in the air, and more preferably has a thermal shrinkage ratio of less than 3% at 250° C. in the air, and most preferably has a thermal shrinkage of less than 3% at 300° C. in the air.

With respect to separators using resin as raw material, stretching process is often carried out in forming the film. Therefore, even though the resin itself expands by heating, at a temperature equal to or higher than the glass transition point, particularly in the vicinity of the melting point, distortion due to stretching is released and shrinkage occurs. The separator functions to maintain insulation between the electrodes, but when the separator shrinks and insulation cannot be maintained, short circuit in the battery could occur. Compared to the wound type batteries, in the stacked type batteries, pressing force to separator between electrodes is low, therefore thermal shrinkage is relatively easy to occur, resulting in a short circuit. In general, separator is designed to be larger than the electrode in preparation for some deviation and contraction. However, if the size of separator is too large, energy density of the battery will reduce, therefore it is preferable to have a margin of a few percent. Thus, when thermal shrinkage ratio of the separator exceeds 3%, there is a higher possibility that separator becomes smaller than the electrode.

Boiling point of the electrolyte solution constituting the battery depends on the solvent to be used, and it is 100° C. to 200° C. If shrinkage ratio is less than 3% even at the boiling point, electrolyte solution volatilizes and is discharged to the outside of the battery system, then ion conduction between the electrodes is blocked and function of the battery is lost.

Therefore, even when heat generation occurs for example in overcharging, the risk of ignition becomes low. On the other hand, if shrinkage ratio of the separator is 3% or more, the separator shrinks and the electrodes are short-circuited and sudden discharge occurs before the electrolyte solution is completely discharged to the outside of the system. Especially if the battery capacity is large, heating amount by the discharge due to the short circuit becomes large.

Thermal shrinkage ratio varies depending on condition in a step of producing separator, such as stretching condition and the like. As a material for separator having low thermal shrinkage ratio even at high temperatures such as boiling point of the electrolyte solution, heat-resistant resin having a melting point higher than boiling point of the electrolyte solution can be used. Specifically, the followings can be used: polyimide, polyamide, polyphenylene sulfide, polyphenylene oxide, polybutylene terephthalate, polyether imide, polyacetal, polytetrafluoroethylene, polychlorotrifluoroethylene, polyamide imide, polyvinylidene fluoride, polyvinylidene chloride, polyvinyl alcohol, phenol resin, urea resin, melamine resin, urethane resin, epoxy resin, cellulose, polystyrene, polypropylene, polyethylene naphthalate or the like.

In order to enhance the insulating property of the separator, it may be coated with an insulating member such as ceramics, or a stacked separator made of different material layers may be used. However, when forming the stacked separator by stacking a plurality of materials, warping of the separators could occur because the material are the heat resistant resin as mentioned above or because there is a difference of shrinking rate in drying. Therefore, it is preferable to select a combination of materials with similar shrinkage ratios in drying so that warping of the separator can be prevented. Alternatively, it is preferable to provide other heat resistant resin on both surfaces of one heat-resistant resin film to prevent warping as separator.

Even for the configuration where insulating member is provided or for the stacked structure as mentioned above, it is also preferable that a thermal shrinkage ratio of the entire separator is less than 3% in electrolyte solution at its boiling point.

Among the above-mentioned materials, a separator made of one or more kinds of resins selected from polyphenylene sulfide, polyimide and polyamide is particularly preferable, because it does not melt even at high temperature and thermal shrinkage ratio is low. These separators use a resin with a high melting point, and the thermal shrinkage ratio is low. For example, shrinkage ratio of a separator made of polyphenylene sulfide resin (280° C.) at 200° C. is 0%. Shrinkage ratio of a separator prepared by aramid resin (no melting point, thermally decomposed at 400° C.) at 200° C. is 0%, and it would reached 3% at 300° C. In polyimide resin separator (no melting point, thermally decomposed at 500° C. or higher), shrinkage ratio at 200° C. is 0%, and it would become only around 0.4% even at 300° C.

Particularly preferable material is a resin composed of an aromatic polyamide, so-called aramid. Aramid is an aromatic polyamide in which one or more aromatic groups are directly linked by an amide bond. Examples of the aromatic group include a phenylene group. Further, two aromatic rings may be bonded by oxygen, sulfur or an alkylene group (for example, a methylene group, an ethylene group, a propylene group or the like). These aromatic groups may have a substituent. Examples of the substituent include an alkyl group (for example, a methyl group, an ethyl group, a propyl group, etc.), an alkoxy group (for example, a methoxy group, an ethoxy group, propoxy group, etc.), halogen (such as chloro group) and the like. In particular, those in which some or all of the hydrogen atoms on the aromatic ring are substituted with halogen groups such as fluorine, bromine, chlorine and the like are preferred, since they have high oxidation resistance and no oxidative deterioration occurs at the positive electrode. Aramid used in the present embodiment may be either para type or meta type. In the present embodiment, it is particularly preferable to use a member made of an aramid resin as the separator, since it does not deteriorate even under high energy density, and it maintains insulation against lithium deposition, therefore entire short circuit can be prevented.

Examples of aramids that can be preferably used in the present embodiment include polymetaphenylene isophthalamide, polyparaphenylene terephthalamide, copolyparaphenylene 3,4′-oxydiphenylene terephthalamide, and others in which hydrogen on the phenylene groups has been substituted.

On the other hand, polyethylene or polypropylene that have been conventionally used as separators for lithium ion batteries shrinks under high temperature condition, and its thermal shrinkage ratio is relatively high. In one example, melting point of polypropylene is around 160° C., but for example it is sometimes shrink by about 5% at 150° C., 90% or more after melting at 200° C. Polyethylene having lower melting point (130° C.) further shrinks. In low energy density battery, when the temperature of battery does not rise so much thanks to high cooling effect or a temperature rising rate is slow, there is no problem even with a polyolefin type separator. However, in applications to high-energy-density batteries, such separators are insufficient for safety.

In order to prevent ignition due to thermal runaway of battery, separator used in one embodiment of the present invention preferably has an oxygen index of 25 or more. The oxygen index means the minimum oxygen concentration at which a vertically supported small test specimen can maintain combustion in a mixed gas of nitrogen and oxygen at room temperature. The higher this value, the higher flame-retardant material. Measurement of oxygen index can be carried out according to JIS K 7201. Examples of the material used for separators having an oxygen index of 25 or more include resins such as polyphenylene sulfide, polyphenylene oxide, polyimide, and aramid.

With respect to a form of the separator, any form such as fiber aggregate such as woven fabric or nonwoven fabric, microporous membrane or the like can be used. Among these, a separator of a microporous membrane is particularly preferable, since lithium is not easily deposited and a short circuit can be prevented. The smaller porosity diameter of the surface of the separator on negative electrode side, the more the deposition of lithium can be suppressed.

Porosity of the microporous membrane used for the separator and porosity ratio (ratio of gap) of the nonwoven fabric may be appropriately set according to characteristics of the lithium ion secondary battery. In order to obtain good rate characteristics of the battery, porosity rate of the separator is preferably 35% or more, and more preferably 40% or more. In order to increase the strength of the separator, porosity rate of the separator is preferably 80% or less, and more preferably 70% or less.

Porosity rate of the separator can be calculated as follows by measuring the bulk density according to JIS P 8118:

Porosity rate (%)=[1−(bulk density p (g/cm³)/theoretical density p₀ (g/cm³) of material]×100

Other measurement methods include a direct observation method using an electron microscope and a press-fit method using a mercury porosimeter.

The porosity diameter of microporous membrane is preferably 1 μm or less, more preferably 0.5 μm or less, and still more preferably 0.1 μm. For a permeation of charged substance, porosity diameter of surface of the microporous membrane on negative electrode side is preferably 0.005 μm or more, more preferably 0.01 μm or more.

As an example, for aramid separator, porosity diameter may be about 0.5 μm, for polyimide separator, porosity diameter may be about 0.3 μm, and for polyphenylene sulfide separator, porosity diameter may be about 0.5 μm.

Thicker separator is more preferable in terms of maintaining insulating properties and strength. On the other hand, in order to increase the energy density of battery, it is preferable that the separator is thin. In the present embodiment, it is preferable to have thickness of 3 μm or more, preferably 5 μm or more, and more preferably 8 μm or more to prevent short circuit and provide heat resistance. Thickness is not more than 40 μm, preferably not more than 30 μm, more preferably not more than 25 μm to satisfy normally required specifications of batteries such as energy density. For instance, thickness of each of aramid separator, polyimide separator, and polyphenylene sulfide separator may be, for example, about 20 μm.

As an index indicating insulating property at high temperature, thickness Ts of the insulating layer is used. There are porosities in the separator, and porosities are also present in electrode mixture layer. In overcharging or the like, temperature of electrode and separator may locally reach 400° C. Therefore, in this case, insulating property at 400° C. is important. In case of resin which melts at 400° C. or lower, porosities of separator are lost and insulating property decrease. In addition, since it enters porosities of the electrode mixture layer, a gap between the electrodes becomes smaller and insulating property decreases. It is required that thickness (Ts) of insulating layer at 400° C. is at least 3 μm or more, preferably 5 μm or more.

[Negative Electrode]

Negative electrode has a structure in which a negative electrode active material layer, formed by integrating negative electrode active material with negative electrode binder, is stacked on a current collector. Negative electrode active material is a material capable of reversibly accepting and releasing lithium ions as charging and discharging.

In one embodiment of the present invention, negative electrode contains metal and/or metal oxide and carbon as negative electrode active material. Examples of metals include Li, Al, Si, Pb, Sn, In, Bi, Ag, Ba, Ca, Hg, Pd, Pt, Te, Zn, La, or alloys of two or more of these. Two or more of these metals or alloys may be mixed and used. In addition, these metals or alloys may contain one or more nonmetallic elements.

Examples of metal oxide include, for example, silicon oxide, aluminum oxide, tin oxide, indium oxide, zinc oxide, lithium oxide, or a composite thereof. In the present embodiment, tin oxide or silicon oxide is preferably included as a negative electrode active material, and it is more preferable that silicon oxide is included. This is because silicon oxide is relatively stable and hardly causes reaction with other compounds. In addition, one or more elements selected from nitrogen, boron and sulfur may be added to metal oxide, for example at an amount of 0.1 to 5 mass %. By doing so, electrical conductivity of the metal oxide can be improved.

Examples of the carbon include graphite, amorphous carbon, diamond-like carbon, carbon nanotube, or a composite thereof. Graphite with high crystallinity has high electrical conductivity and is excellent in adhesiveness to a negative electrode current collector made of a metal such as copper, and in voltage flatness. On the other hand, since amorphous carbon with low crystallinity has a relatively small volume expansion, it has a high effect of relaxing the volume expansion of the entire negative electrode. In addition, degradation due to nonuniformity such as crystal grain boundaries and defects is unlikely to occur.

The feature of metals and metal oxides is that capacity of lithium to accept is far greater than that of carbon. Therefore, by using a large amount of metal and metal oxide as the negative electrode active material, the energy density of the battery can be improved. To achieve high energy density, it is preferable that the content ratio of metal and/or metal oxide in the negative electrode active material is high. Metals and/or metal oxides are compounded in the negative electrode such that the lithium acceptable amount of carbon contained in the negative electrode is less than the lithium releasable amount of the positive electrode. In the present specification, lithium releasable amount of the positive electrode and the lithium acceptable amount of the carbon contained in the negative electrode means the respective theoretical capacities. The ratio of lithium acceptable amount of carbon contained in the negative electrode with respect to the amount of lithium that can be released from the positive electrode is preferably 0.95 or less, more preferably 0.9 or less, and further preferably 0.8 or less. As the amount of the metal and/or metal oxide increases, the capacity of the negative electrode as a whole increases, this is preferable. The metal and/or the metal oxide is preferably contained in the negative electrode in an amount of 0.01 mass % or more of the negative electrode active material, more preferably 0.1 mass % or more, and further preferably 1 mass % or more. However, the metal and/or metal oxide has a larger change in volume when absorbing and releasing lithium than carbon. Then, the electrical connection may be lost in some cases. Therefore, it is 99 mass % or less, preferably 90 mass % or less, more preferably 80 mass % or less. As described above, the negative electrode active material is a material capable of reversibly accepting and releasing lithium ions with charge and discharge in the negative electrode. It does not include other binders.

As a binder for the negative electrode, polyvinylidene fluoride, vinylidene fluoride-hexafluoropropylene copolymer, vinylidene fluoride-tetrafluoroethylene copolymer, styrene-butadiene copolymer rubber, polytetrafluoroethylene, polypropylene, polyethylene, acrylic, polyimide, polyamideimide, or the like can be used. In addition to the above, styrene butadiene rubber (SBR) or the like can be used. When an aqueous binder such as an SBR emulsion is used, a thickener such as carboxymethyl cellulose (CMC) can also be used. Amount of the binder for the negative electrode to be used is preferably 0.5 to 20 pts. mass with respect to 100 pts. mass of the negative electrode active material from the viewpoint of sufficient binding force and high energy in a trade-off relationship. The above negative electrode binders may be mixed and used.

Negative electrode active material can be used together with conductive auxiliary material. Specifically, as the conductive auxiliary material, the same materials as specifically exemplified in the positive electrode can be used. The amount of use may be the same as well.

As a negative electrode current collector, from the viewpoint of electrochemical stability, aluminum, nickel, copper, silver, and alloys thereof are preferable. Examples of the shape include a foil, a flat plate shape, and a mesh shape.

Examples of method for forming negative electrode active material layer include a doctor blade method, a die coater method, a CVD method, a sputtering method, and the like. After forming negative electrode active material layer in advance, a thin film of aluminum, nickel or an alloy thereof may be formed by a method such as vapor deposition, sputtering or the like to obtain a negative electrode current collector.

[Positive Electrode]

Positive electrode means an electrode on high potential side in a battery. As an example, positive electrode includes a positive electrode active material capable of reversibly accepting and releasing lithium ions as charging and discharging. Positive electrode has a structure in which positive electrode active material layer, in which positive electrode active material is integrated by positive electrode binder, is stacked on current collector. In one embodiment of the present invention, positive electrode has a charge capacity per unit area of 3 mAh/cm² or more, preferably 3.5 mAh/cm² or more. From the viewpoint of safety and the like, charge capacity per unit area of the positive electrode is preferably 1 mAh/cm² or less. Here, chargeable capacity per unit area is calculated from the theoretical capacity of the active material. That is, chargeable capacity of the positive electrode per unit area is calculated by (theoretical capacity of the positive electrode active material used for positive electrode)/(area of positive electrode). It is noted that the area of the positive electrode refers to the area of one surface, not both surfaces of the positive electrode.

To increase energy density of the positive electrode, positive electrode active material used for positive electrode accepts and releases lithium, and is preferably a compound having a higher capacity. As a high capacity compound, a lithium nickel composite oxide obtained by substituting a part of Ni of nickel lithium nickel (LiNiO₂) with another metal element can be used, and a layered lithium nickel composite oxide represented by the following formula (A) is preferred:

Li_{y}Ni₍₁₋ₓ₎MxO₂ (A)

(Here, 0≤x<1, 0<y≤1.2, M is at least one element selected from the group consisting of Co, Al, Mn, Fe, Ti and B).

As a compound represented by the formula (A), it is preferable that amount of Ni is high, that is, x in the formula (A) is preferably less than 0.5, more preferably 0.4 or less. As such a compound, for example,

Li_{α}Ni_{β}Co_{γ}Mn_{δ}O₂(1≤α≤1.2, β+γ+δ=1, β≤0.7, γ≤0.2), Li_{α}Ni_{β}Co_{γ}Al_{δ}O₂(1≤α≤1.2, β+γ+δ=1, β≤0.7, γ≤0.2), and the like. In particular, Li_{α}Ni_{β}Co_{γ}Mn_{δ}O₂(0.75 ≤β≤0.85, 0.05≤γ≤0.15, 0.10≤δ≤0.20)can be used. More specifically, for example, LiNi_{0.8}Co_{0.05}Mn_{0.15}O₂, LiNi_{0.8}Co_{0.1}Mn_{0.1}O₂, LiNi_{0.8}Co_{0.15}Al_{0.05}O₂, LiNi_{0.8}Co_{0.1}Al_{0.1}O₂, and the like can be preferably used.

From the viewpoint of thermal stability, it is also preferable that the content of Ni does not exceed 0.5, that is, x in formula (A) is 0.5 or more. It is also preferable that the number of specific transition metals does not exceed half. Such compounds include Li_{α}Ni_{β}Co_{γ}Mn_{δ}O₂(1≤α≤1.2, β+γ+δ=1, 0.2≤β≤0.5, 0.1≤γ≤0.4, 0.1≤δ≤0.4). More specifically, LiNi_{0.4}Co_{0.3}Mn_{0.3}O₂ (abbreviated as NCM433), LiNi_{1/3}Co_{1/3}Mn_{1/3})₂, LiNi_{0.5}Co_{0.2}Mn_{0.3}O₂ (abbreviated as NCM 523), LiNi_{0.5}Co_{0.3}Mn_{0.2}O₂ (abbreviated as NCM 532) and the like (including those in which the content of each transition metal in these compounds varied by about 10%).

Further, two or more compounds represented by the formula (A) may be used in combination. For example, NCM532 or NCM 523 and NCM 433 are mixed in a ratio of 9:1 to 1:9 (typically 2:1) is also preferably used. Material having a high content of Ni in the formula (A) (x is 0.4 or less) and material in which the Ni content does not exceed 0.5 (x is 0.5 or more, for example NCM 433) may be mixed to obtain battery with high capacity and high thermal stability.

In addition to the above, for example, LiMnO₂, LiₓMn₂ Z-20 (sericite) and the like are available as the positive electrode active material. In addition, SiO₂, Al₂O₃, and ZrO can be produced by the method disclosed in JP-A No. 2003-206475.

Average particle diameter of the inorganic particles is preferably in the range of 0.005 to 10 μm, more preferably 0.1 to 5 μm, particularly preferably 0.3 to 2 μm. When the average particle diameter of the inorganic particles is in the above range, it becomes easy to manufacture a porous film having a homogeneous uniform thickness, since dispersion state of the porous film slurry can be easily controlled. Furthermore, adhesion to the binder is improved, and peeling-off of the inorganic particles is prevented even when the porous film is wound. Even if the porous membrane is thinned, sufficient safety can be achieved. In addition, since it is possible to suppress an increase of particle filling ratio in the porous film, it is possible to suppress a decrease in ion conductivity in the porous film. Furthermore, the porous membrane can be made thin.

The average particle diameter of the inorganic particles can be determined as follows: 50 primary particles are arbitrarily selected from an SEM (Scanning Electron Microscope) image in an arbitrary field of view, the image is analyzed, and each particle and average particle diameter is obtained as the average value of the equivalent circle diameters.

The particle diameter distribution (CV value) of the inorganic particles is preferably 0.5 to 40%, more preferably 0.5 to 30%, particularly preferably 0.5 to 20%. By setting particle size distribution of the inorganic particles within the above range, it is possible to maintain a predetermined gap between the nonconductive particles. Therefore, it is possible to inhibit movement of lithium in the secondary battery of the present invention and to suppress the resistance from increasing. The particle diameter distribution (CV value) of the inorganic particles can be determined as follows: inorganic particles are observed by an electron microscope, the particle sizes are measured for 200 or more particles, and average particle size and the standard deviation of the particle diameter are determined, then calculate (standard deviation of particle diameter)/(average particle diameter). The larger the CV value, the larger the variation in particle diameter is.

From the view point of suppressing aggregation of inorganic particles and optimizing fluidity of the porous membrane slurry described later, BET specific surface area of the inorganic particles used in one embodiment of the present invention is specifically preferably 0.9 to 200 m²/g, more preferably 1.5 to 150 m²/g.

When coating material for forming a porous insulating layer is a nonaqueous solvent, a polymer which is dispersed or dissolved in a nonaqueous solvent can be used. As examples of the polymer dispersed or dissolved in the nonaqueous solvent, such materials but not limited to as polyvinylidene fluoride (PVdF), polytetrafluoroethylene (PTFE), polyhexafluoropropylene (PHFP), polytrifluoroethylene chloride (PCTFE), polyperfluoroalkoxyfluoro ethylene and the like can be used as a binder.

Since insulating layer in one embodiment of the present invention is adjacent to the positive electrode, it is preferable that it is stable at a high potential. In this point, inorganic particle is preferable since it is more stable than organic particle. Further, as binder binding the insulating particles of the insulating layer, those having excellent withstanding voltage are preferable. It is preferable that the value of HOMO obtained by molecular orbital calculation is small. It can be used as a binder, but not limited to, such as polyvinylidene fluoride (PVdF), polytetrafluoroethylene (PTFE), polyhexafluoropropylene (PHFP), polytrifluorochloroethylene (PCTFE), polyperfluoroalkoxyfluoroethylene and the like.

Besides the above, a binder used for binding the mixture layer can be used.

When the coating material for forming a porous insulating layer, which will be described later, is a water-based solvent (a solution using water or a mixed solvent containing water as a main component as a dispersion medium of a binder), polymer can be used which is dispersed or dissolved in aqueous solvent. As a polymer dispersed or dissolved in an aqueous solvent, for example, an acrylic resin can be used. As the acrylic resin, homopolymers obtained by polymerizing monomers such as acrylic acid, methacrylic acid, acrylamide, methacrylamide, 2-hydroxyethyl acrylate, 2-hydroxyethyl methacrylate, methyl methacrylate, ethylhexyl acrylate are preferably used. Acrylic resin may be a copolymer obtained by polymerizing two or more of the above monomers. Further, it may be a mixture of two or more of the homopolymer and the copolymer. In addition to the above-mentioned acrylic resin, polyolefin resins such as styrene butadiene rubber (SBR) and polyethylene (PE), polytetrafluoroethylene (PTFE), and the like can be used. These polymers can be used singly or in combination of two or more kinds. Among them, it is preferable to use an acrylic resin. The form of the binder is not particularly limited, and particles in the form of particles (powder) may be used as they are, or those prepared in a solution state or an emulsion state may be used. Two or more kinds of binders may be used in different forms.

Porous insulating layer may contain a material other than the above mentioned inorganic filler and binder, if necessary. Examples of such a material include various polymer materials that can function as a thickener of the below-described coating material for forming a porous insulating layer. In particular, when aqueous solvent is used, it is preferable to contain a polymer functioning as the thickener. As the polymer functioning as the thickener carboxymethyl cellulose (CMC) or methyl cellulose (MC) is preferably used.

Although not particularly limited, ratio of the inorganic filler (that is, the total amount of the inorganic filler in the separator side portion and the electrode side surface portion) to the entire porous insulating layer is about 70 mass % or more (for example, 70 mass % to 99 mass %) is preferred, preferably 80 mass % or more (for example, 80 mass % to 99 mass %), particularly preferably about 90 mass % to 99 mass %.

Ratio of the binder in the porous insulating layer is preferably about 30 mass % or less, preferably 20 mass % or less, more preferably 10 mass % or less (for example, about 0.5 mass % to 3 mass %). In the case where a porous insulating layer forming component other than the inorganic filler and the binder is contained (for example, a thickening agent is contained), the content ratio of the thickener is preferably about 3 mass % or less, more preferably about 2 mass % or less (for example, approximately 0.5 mass % to 1 mass %). If the rate of the binder is too low, strength (shape retentively) of the porous insulating layer itself is lowered, and problems such as cracking and peeling may occur. If the rate of the binder is too high, the gaps between the particles of the porous insulating layer become insufficient, and the ion permeability of the porous insulating layer may decrease in some cases.

To maintain the conductivity of the ions, porosity rate (rate of space) (the ratio of the porosity volume to the apparent volume) of the porous insulating layer is needed to be preferably 20% or more, more preferably 30% or more. However, when the porosity is too high, falling off or cracking occurs due to friction or impact of the porous insulating layer. Therefore, it is preferably 80% or less, more preferably 70% or less.

Porosity can be calculated based on a ratio of the materials constituting the porous insulating layer, the true specific gravity and coating thickness.

<Forming of Porous Insulating Layer>

Next, a method of forming the porous insulating layer will be described. As a material for forming the porous insulating layer, paste (including slurry or ink state. The same as below.) is used, in which an inorganic filler, a binder and a solvent are mixed and dispersed.

As a solvent to be used for a coating material for forming a porous insulating layer, water or a mixed solvent mainly containing water can be used. As a solvent other than water constituting such a mixed solvent, one or two or more kinds of organic solvents that can be uniformly mixed with water can be selected appropriately (lower alcohol, lower ketone, etc.). Alternatively, it may be an organic solvent such as N-methylpyrrolidone (NMP), pyrrolidone, methyl ethyl ketone, methyl isobutyl ketone, cyclohexanone, toluene, dimethylformamide, dimethylacetamide, or a combination of two or more thereof. Content of the solvent in the coating material for forming a porous insulating layer is not particularly limited, but it is preferably about 40 to 90 mass %, particularly about 50 mass % of the entire coating material.

Operation of mixing the inorganic filler and binder into the solvent can be carried out by using suitable kneader such as a ball mill, a homodisper, a disperser mill, CLEARMIX (registered trademark), FILMIX (registered trademark), a ultrasonic disperser.

The operation of applying the coating material for forming a porous insulating layer can be carried out by a conventional general coating means without any particular limitation. For example, by using a suitable coating apparatus such as a gravure coater, a slit coater, a die coater, a comma coater, a dip coat, etc., coating can be carried out to form a uniform thickness porous insulating layer with predetermined volume.

Thereafter, the coated product is dried by an suitable drying apparatus (typically at a temperature lower than a melting point of a separator, for example, 110° C. or lower, for example 30 to 80° C.). Thereby, the solvent in the coating material for forming the porous insulating layer may be preferably removed.

[Electrolyte Solution]

The electrolyte solution of the lithium ion secondary battery according to the present embodiment is not particularly limited but is preferably a nonaqueous electrolyte solution which includes a nonaqueous solvent and a supporting salt that are stable at an operating potential of the battery.

Examples of nonaqueous solvents include cyclic carbonates such as propylene carbonate (PC), ethylene carbonate (EC) and butylene carbonate (BC); dimethyl carbonate (DMC), diethyl carbonate (DEC), ethyl methyl carbonate (EMC) chain carbonates such as dipropyl carbonate (DPC); propylene carbonate derivatives, aliphatic carboxylic acid esters such as methyl formate, methyl acetate, ethyl propionate and the like; ethers such as diethyl ether and ethyl propyl ether, trimethyl phosphate, triethyl phosphate, tripropyl phosphate, trioctyl phosphate, triphenyl phosphate, and other phosphoric acid esters, and fluorine atom-substituted at least part of the hydrogen atoms of these compounds with fluorine atoms of aprotic organic solvents, and the like.

In a secondary battery containing a metal or a metal oxide as a negative electrode, they deteriorate and collapse, thereby increasing the surface area and promoting decomposition of the electrolyte in some cases. The gas generated by decomposition of the electrolytic solution is one of the factors that inhibit the acceptance of lithium ions of the negative electrode. Therefore, in a lithium ion secondary battery containing a large proportion of metal and/or metal oxide in the negative electrode as in the present invention, a solvent having high oxidation resistance and difficult to decompose is preferable. As a solvent having high oxidation resistance, for example, fluorinated aprotic organic solvents such as fluorinated ether and fluorinated phosphate ester can be mentioned.

In addition, it is possible to use cyclic or cyclic (meth) acrylate such as ethylene carbonate (EC), propylene carbonate (PC), butylene carbonate (BC), dimethyl carbonate (DMC), diethyl carbonate (DEC), ethyl methyl carbonate (MEC), dipropyl carbonate chain carbonates are also particularly preferred solvents.

As a nonaqueous solvent, one type may be used alone, or two or more types may be used in combination.

Examples of supporting salts include lithium salts such as LiPF₆, LiAsF₆, LiAlCl₄, LiClO₄, LiBF₄, LiSbF₆, LiCF₃SO₃, LiC₄F₉SO₃, LiC(CF₃SO₂)₃, LiN(CF₃SO₂)₂. As a supporting salt, one kind may be used alone, or two kinds or more may be used in combination. LiPF₆ is preferable from the viewpoint of cost reduction.

Electrolyte solution may further contain additives. The additives are not particularly limited, but halogenated cyclic carbonates, unsaturated cyclic carbonates, cyclic or chain disulfonic acid esters and the like can be used. By adding these compounds, battery performance such as cycle characteristics can be improved. This is presumably because these additives decompose during charging and discharging of the lithium ion secondary battery to thereby form a film on a surface of the electrode active material, leading to suppressing the decomposition of electrolyte solution and supporting salt.

[Method for Manufacturing Lithium Ion Secondary Battery]

Lithium ion secondary battery according to this embodiment can be manufactured by the following method. Here, taking a stacked laminate type lithium ion secondary battery as an example, example of the manufacturing method will be described.

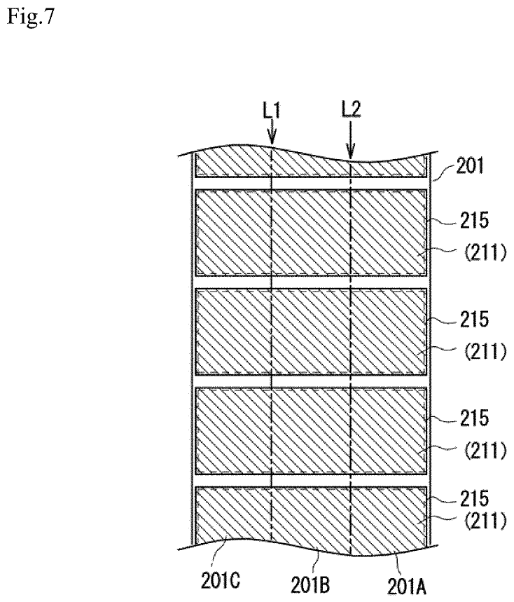

Preparation of the positive electrode and the negative electrode will be briefly described. First, as shown in FIG. 6, active material layer 211 is coated on an elongated metal foil 201.

Then, as shown in FIG. 7, an insulating layer 215 is coated so as to cover the active material layer 211. It is noted that the coating process of FIG. 6 and the coating process of FIG. 7 may be carried out at the same time.

Thereafter, in a slitting process, the metal foil 211 is cut along the lines L1 and L2 in the longitudinal direction, and cut into metal foils 201A, 201B, and 201C.

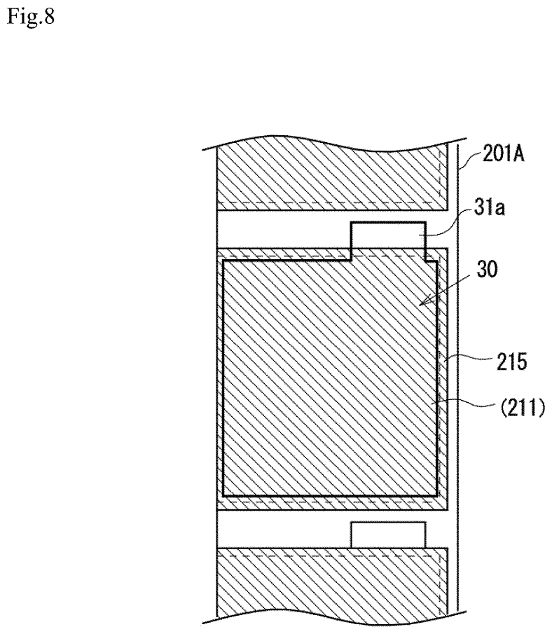

Next, as shown in FIG. 8, punching process is carried out on the metal foils 201A to 201C to thereby obtain the electrode 30. The electrode 30 has a substantially square shape as a whole, and has a projecting portion 31a on a part of its outer peripheral portion. The projecting portion 31a is a portion for electrical connection, basically, no active material layer or insulating layer is formed. Negative electrode can be produced in the same manner as described above, but in the case of the negative electrode, it is not necessary to form an insulating layer.

Subsequently, production of a battery element and enclosing process of the battery element into film package will be described. First, a stacked assembly is produced, in dry air or an inert atmosphere, by arranging the positive and negative electrodes prepared as described above to face each other with a separator interposed therebetween. Next, the stacked assembly is placed into an outer package (container), and an electrolyte solution is injected so that the electrodes can be impregnated with the electrolyte solution.

Thereafter, the opening of the outer package is sealed to complete a lithium ion secondary battery. Here, the battery having the stacked structure is one of preferable forms, because its deformation of separator due to thermal shrinkage of base material is remarkable, and a significant effect can be obtained by the present invention.

3. Other composition

[Assembled Battery]

A plurality of lithium ion secondary batteries according to the present embodiment can be combined to form an assembled battery. For example, two or more lithium ion secondary batteries according to this embodiment may be connected in series, parallel or both. By connecting in series and/or in parallel manner, it is possible to freely adjust capacitance and voltage. The number of lithium ion secondary batteries provided in the assembled battery can be appropriately set according to the battery capacity and output.

[Vehicle]

Lithium ion secondary battery or assembled battery according to the present embodiment can be used in a vehicle. Examples of vehicles according to the present embodiment include hybrid vehicles, fuel cell vehicles, electric vehicles (all of which are four-wheel vehicles (for example, commercial vehicles such as passenger cars, trucks, buses, or light vehicles), motorcycles and tricycles. It is noted that the vehicle according to the present embodiment is not limited to an automobile, but can be used as various power sources for other vehicles (for example, movable object such as electric trains).

[Power Storage Device]

Lithium ion secondary battery or the assembled battery according to the present embodiment can be used for a power storage device. For example, the power storage device according to the present embodiment is connected between a commercial power supply to be supplied to ordinary households and a load such as home electric appliances. The power storage device is used as a backup power source or auxiliary power when a power failure or the like occurs. In addition, the power storage device may also be used as a storage device for large-scale power storage such as photovoltaic power generation, to stabilize power output with a large time variation by renewable energy.

[Others]

Furthermore, the lithium ion secondary battery or the assembled battery according to the present embodiment can be used as a power source of a mobile phone, a mobile device such as a notebook computer, and the like.

### EXAMPLES

<Example 1>

Manufacturing of a battery of this example will be described.

(Positive Electrode)

Lithium nickel composite oxide (LiNi_{0.80}Mn_{0.15}Co_{0.5}O₂) as a positive electrode active material, carbon black as a conductive auxiliary material and polyvinylidene fluoride as a binder were measured at weight ratio of 90:5:5. They were kneaded using N-methylpyrrolidone to prepare positive electrode slurry. The prepared positive electrode slurry was applied on an aluminum foil having a thickness of 20 μm as a current collector, dried and further pressed to obtain a positive electrode.

Next, alumina (average particle diameter 1.0 μm) and polyvinylidene fluoride as a binder were measured at weight ratio of 90:10. They were kneaded using N-methylpyrrolidone to prepare slurry for insulating layer. This was coated on a positive electrode with a gravure coater dried and further pressed to obtain an insulating layer. When the section was observed with an electron microscope, thickness of the insulating layer was 3 μm (porosity ratio 55%).

(Negative Electrode)

Artificial graphite particles (average particle size 8 μm) as a carbon material, carbon black as a conductive auxiliary material, and mixture of styrene-butadiene copolymer rubber: carboxymethyl cellulose at 1:1 weight ratio as a binder was measured at weight ratio of 97:1:2. They were kneaded using distilled water to prepare negative electrode slurry. The prepared negative electrode slurry was applied on a copper foil having a thickness of 15 μm as a current collector, dried and further pressed to obtain a negative electrode.

(Assembly of Secondary Battery)

Aluminum terminal and nickel terminal were welded to each of the prepared positive electrode and negative electrode. These were stacked via a separator to prepare an electrode element. The electrode element was sheathed with laminated film and electrolyte solution was injected into the inside of the laminated film. As a separator, a single layer of wholly aromatic polyamide (aramid) microporous membrane was used. The aramid microporous membrane had a thickness of 25 μm, a porosity size of 0.5 μm, and a porosity rate of 60%.

Thereafter, laminated film was thermally fused and sealed while reducing the pressure inside the laminated film. As a result, flat type secondary battery before initial charging were prepared. As the laminated film, a polypropylene film vapor-deposited with aluminum was used. For the electrolyte solution, a solution was used, which contained 1.0 mol/l of LiPF₆ as an electrolyte and a mixed solvent of ethylene carbonate and diethyl carbonate as a nonaqueous electrolytic solvent (7:3 (volume ratio)).

(Appearance of Separator)

Visual evaluation was carried out for separator before assembled into the battery. To eliminate the influence of static electricity, the separator cut into 10 cm square was placed on a metal plate, and no warp or curl was observed. In this case the judgment is “Good”, while the outer peripheral portion is warped, and when it is raised by 5 mm or more, it is judged as “NG”. The results are shown in Table 1.

[Evaluation of Secondary Battery]

(High Temperature Test)

The prepared secondary battery was charged to 4.2V and left in a constant temperature bath at 160° C. for 30 minutes. There was no rupture or smoke of the battery. In this case, it is judged as good, while when ignited it is judged as NG. The results are shown in Table 1.

(Degradation of Separator Due to Overcharge)

The prepared secondary battery was charged to 5V at 1 C, left for 4 weeks, and discharged and disassembled. No abnormality such as discoloration indicating signs of oxidative deterioration was observed on the positive electrode side of the separator. In this case, it is judged as Good, while when abnormality such as coloring is confirmed it is judged as NG. The results are shown in Table 1.

(Resistance Increase)

After charging the prepared secondary battery to 4.2V, the impedance was measured. The results are shown in Table 1.

TABLE 1

| | | Insulating layer | | | | High- | | |
|---|---|---|---|---|---|---|---|---|
| | | Apply on | | | | temperature | Overcharging | Internal |
| | | positive | Apply on | Thickness | Warping of | test | test | resistance |
| | Separator | electrode | separator | (μm) | separator | 160° C. | 5 V | (mΩ) |
| Example 1 | Aramid | Alumina | | 3 | ◯ | ◯ | ◯ | 3 |
| Example 2 | Aramid | Silica | | 3 | ◯ | ◯ | ◯ | 3 |
| Example 3 | Polyphenylenes | Alumina | | 3 | ◯ | ◯ | ◯ | 3 |
| | little | | | | | | | |
| Example 4 | Polyimide | Alumina | | 3 | ◯ | ◯ | ◯ | 3 |
| Example 5 | Aramid | | Alumina | 3 | X | ◯ | Δ Slightly | 3 |
| | | | | | | | Yellowing in | |
| | | | | | | | insulating layer | |
| Example 6 | Aramid | | Alumina | 3 + 3 | ◯ | ◯ | Δ Slightly | 4 |
| | | | | | | | Yellowing in | |
| | | | | | | | insulating layer | |
| Example 7 | Polyimide | | Alumina | 3 | X | ◯ | Δ Slightly | 3 |
| | | | | | | | Yellowing in | |
| | | | | | | | insulating layer | |
| Comparative | Polyolefin | Alumina | | 3 | ◯ | X | Δ Slightly | 3 |
| example 1 | | | | | | | Yellowing | |
| Comparative | Aramid | — | | | ◯ | ◯ | X Yellowing | 3 |
| example 2 | | | | | | | | |
| Comparative | Polyolefin | — | Alumina | 3 | X | X | Δ Slightly | 3 |
| example 3 | | | | | | | Yellowing | |
| Comparative | Aramid | Alumina | | 30 | ◯ | ◯ | ◯ | 8 |
| example 4 | | | | | | | | |
| Comparative | Polyolefin | — | Aramid | 3 | X | X | Δ Slightly | 3 |
| example 5 | | | | | | | Yellowing | |
| Comparative | Polyphenylenes | — | | | ◯ | ◯ | X Yellowing | 3 |
| example 6 | ulfide | | | | | | | |
| Comparative | Polyimide | — | | | ◯ | ◯ | X Yellowing | 3 |
| example 7 | | | | | | | | |

<Example 2>

Insulating particles used for insulating layer were silica (average particle diameter: 1.0 μm). Other than that, the battery was prepared under the same conditions as in Example 1 and evaluated. The results are shown in Table 1.

<Example 3>

Separator was made of microporous polyphenylene sulfide (thickness 20 μm, porosity size 0.5 μm, and porosity rate 40%). Other than that, the battery was prepared under the same conditions as in Example 1 and evaluated. The results are shown in Table 1.

<Example 4>

Separator was a polyimide separator (thickness 20 μm, porosity size 0.3 μm, and porosity rate 80%). Other than that, the battery was prepared under the same conditions as in Example 1 and evaluated. The results are shown in Table 1.

<Example 5>

Instead of the aqueous type, the following was used for insulating layer slurry. Mixture of alumina (1 μm) and styrene-butadiene copolymer rubber: carboxymethyl cellulose in weight ratio of 1:1 was measured at weight ratio of 96:4. They were kneaded using distilled water to prepare insulating layer slurry. This was applied not on the positive electrode but on the aramid separator. Other than the above, the same battery as in Example 1 was prepared and evaluated. The results are shown in Table 1(Thickness 3 μm, porosity ratio 55%).

Warp occurred in the separator, therefore it took a long time to assemble.

<Example 6>

Insulating layer slurry was applied of both sides of the aramid separator. Other than that, the same battery as in Example 5 was prepared. The separator coated on its both sides had no warp and was easy to assemble.

<Example 7>

Separator was made of polyimide separator (thickness 20 μm, porosity size 0.3 μm, and porosity rate 80%). Other than that, the same battery as in Example 5 was prepared and evaluated. The results are shown in Table 1.

<Comparative Example 1>

Separator was a microporous polypropylene separator (thickness 25 μm, porosity size 0.06 μm, and porosity rate 55%). Other than that, the battery was prepared under the same conditions as in Example 1 and evaluated. The results are shown in Table 1.

<Comparative Example 2>

Insulating layer was not coated on the positive electrode. Other than that, the battery was prepared under the same conditions as in Example 1 and evaluated. The results are shown in Table 1.

<Comparative Example 3>

Separator was a microporous polypropylene separator (thickness 25 μm, porosity size 0.06 μm, and porosity rate 55%) coated with 3 μm ceramic layer. Other than that, a battery was prepared under the same conditions as in Example 1 and evaluated. The results are shown in Table 1.

<Comparative Example 4>

The thickness of insulating layer was 30 μm. Other than that, a battery was prepared under the same conditions as in Example 1 and evaluated. The results are shown in Table 1.

<Comparative Example 5>

Separator was a microporous polypropylene separator (thickness 25 μm, porosity diameter 0.06 μm, and porosity rate 55%), and aramid was used as insulating layer. Other than that, a battery was prepared under the same conditions as in Example 1 and evaluated. As insulating layer of aramid, slurry (aramid resin/DMAc/TPG=5 mass %/85.5 mass %/14.5 mass %) was used in which aramid resin was dissolved in the mixed solution tripropylene glycol (TPG) as a poor solvent in dimethylacetamide (DMAc). It was applied on a polypropylene separator. After spraying with a coagulating liquid (water/DMAc/TPD=50 mass %/45 mass %/5 mass %), washing with water and drying, a porous aramid insulating layer (thickness: 3 μm) was obtained. Battery was assembled so as to face the negative electrode. The results are shown in Table 1.

<Comparative Example 6>

An insulating layer was not coated on the positive electrode. Other than that, the battery was prepared under the same conditions as in Example 3 and evaluated. The results are shown in Table 1.

<Comparative Example 7>

An insulating layer was not coated on the positive electrode. Other than that, a battery was prepared under the same conditions as in Example 4 and evaluated. The results are shown in Table 1.

According to the results of comparative examples 1, 3, and 5, when a polyolefin having low heat resistance was used as the substrate, a short circuit occurred internally and ignition occurred (because the separator shrank during the high-temperature test).

In comparative examples 2, 6 and 7, resin having high heat resistance were used as separators. Therefore, ignition did not occur in the high-temperature test. However, yellowing, sign of deterioration, was observed on the surface of the separator facing the positive electrode after the overcharging test.

In comparative example 5, aramid, low performance of oxidation resistance, was used on the negative electrode side, while polyolefin layer was used as the insulating layer. Therefore, deterioration of the separator was not observed. In comparative example 4, since the insulating layer has a thickness of 30 μm, safety and overcharge durability are considered to be high. However, the internal resistance of the battery was increased, resulting in low practicality. Internal resistance depends on the configuration such as the capacity (electrode area) of the battery, but in this example, the internal resistances of the batteries of other examples and comparative examples are about 3 mΩ. Therefore, with reference to this, internal resistance is preferably twice (6 mΩ) or less, more preferably 1.5 times (4.5 mΩ) or less.

According to the results of examples 1 and 2, both the alumina and silica showed the effect of suppressing oxidative deterioration of aramid in insulating layer.

In examples 5 and 7 and comparative examples 3 and 5, separators are provided with insulating layers. Therefore, in the drying step after coating, a difference occurs in shrinkage ratio between the separator and the insulating layer. Accordingly, the separator warps, and the assembly of the battery become difficult. In example 6, since the both sides were coated with insulating layers were, there was almost no warping.

The present application discloses the followings:
1. A lithium ion secondary battery in which a positive electrode and a negative electrode are stacked alternatively via a separator,
wherein the separator is a single layer and is not melted or softened at at least 200° C., a thermal shrinkage ratio of the separator being 3% or below, wherein an insulating layer is formed on a surface of the positive electrode, the surface facing to the separator.
2. The lithium ion secondary battery according to the above, wherein the separator is made of a material containing aramid, polyimide, or polyphenylene sulfide.
3. The lithium ion secondary battery according to the above, wherein a thickness of the insulating layer is 1 μm or more and less than 10 μm.
4. The lithium ion secondary battery according to the above, wherein the material for forming the insulating layer contains inorganic particle and a binder.
5. The lithium ion secondary battery according to the above, wherein the inorganic particle includes one or more member selected from the group consisting of aluminum oxide and silicon oxide.
6. The lithium ion secondary battery according to the above, wherein the binder includes one or more members selected from the group consisting of polyvinylidene fluoride (PVdF), polytetrafluoroethylene (PTFE), and polyhexafluoropropylene (PHFP).
7. The lithium ion secondary battery according to the above, wherein the binder has a HOMO value of −12 or less.
8. A lithium ion secondary battery in which a positive electrode and a negative electrode are stacked alternatively via a separator,
wherein the separator is a single layer is not melted or softened at at least 200° C., and a thermal shrinkage ratio of the separator is 3% or below,
   wherein an insulating layer is formed on a surface of the separator, the surface facing to the positive electrode.

As described above, according to one embodiment of the present invention, between positive electrode and separator, insulating layer may be formed not on the positive electrode side but on separator side. In this case, a configuration may be adopted in which a first insulating layer is formed on one surface of the separator while a second insulating layer is formed on the other surface.
9. The lithium ion secondary battery according to the above, wherein the separator is made of a material containing aramid, polyimide, or polyphenylene sulfide.
10. The lithium ion secondary battery according to the above,
   wherein a thickness of the insulating layer is 1 μm or more and less than 10 μm.
11. The lithium ion secondary battery according to the above,
   wherein the material for forming the insulating layer contains inorganic particle and a binder.
12. The lithium ion secondary battery according to the above,
   wherein the inorganic particle includes one or more member selected from the group consisting of aluminum oxide and silicon oxide.
13. The lithium ion secondary battery according to the above,
   wherein the binder includes one or more members selected from the group consisting of polyvinylidene fluoride (PVdF), polytetrafluoroethylene (PTFE), and polyhexafluoropropylene (PHFP).
14. The lithium ion secondary battery according to the above, wherein the binder has a HOMO value of −12 or less.

### EXPLANATION OF SYMBOLS

1 FILM PACKAGED BATTERY

10 FILM PACKAGE

15 HEAT FUSION PART

20 BATTERY ELEMENT

25 SEPARATOR

30 POSITIVE ELECTRODE

40 NEGATIVE ELECTRODE

70 INSULATING LAYER

1. A lithium ion secondary battery, comprising:
a positive electrode having a current collector, a positive electrode active material layer, and a porous insulating layer,
a negative electrode, and
a separator,
wherein the positive electrode and the negative electrode are stacked alternately via the separator,
wherein the separator is a single layer and is not melted or softened at least 200° C., a thermal shrinkage ratio of the separator being 3% or below,
wherein the porous insulating layer contains inorganic particles and a binder, and is formed on an entire of a surface of the positive electrode, the surface facing to the separator,
wherein the positive electrode is obtained by applying a porous insulating layer composition containing the inorganic particles and the binder directly onto the surface of the positive electrode, and the porous insulating layer composition is not applied on a surface of the separator,
wherein the porous insulating layer has a uniform thickness of the entire porous insulating layer that includes pores, and a thickness of the porous insulating layer is 1 μm or more and less than 10 μm,
wherein the inorganic particles are aluminum oxide,
wherein the binder is polyvinylidene fluoride (PVdF), and
wherein the positive electrode active material layer includes a lithium nickel composite oxide as a positive electrode active material, and the lithium nickel composite oxide is represented by formula (A),
Li_{y}Ni₍₁₋ₓ₎MₓO₂ (A),
wherein, in formula (A), 0<x<0.5, 0<y≤1.2, and M is at least one element selected from the group consisting of Co, Al, Mn, Fe, Ti and B.

2. The lithium ion secondary battery according to claim 1, wherein the separator is made of a material containing aramid, polyimide, or polyphenylene sulfide.

3. The lithium ion secondary battery according to claim 1, wherein the binder has a HOMO value of −12 or less.

4. The lithium ion secondary battery according to claim 1, wherein the porous insulating layer is formed directly on the surface of the positive electrode.

5. The lithium ion secondary battery according to claim 1, wherein the inorganic particles and the binder are dispersed in the porous insulating layer.

6. The lithium ion secondary battery according to claim 1, wherein the separator is made of a material containing aramid.

7. The lithium ion secondary battery according to claim 1, wherein the separator is made of a material containing polyphenylene sulfide.

8. The lithium ion secondary battery according to claim 1, wherein the separator is made of aramid or polyphenylene sulfide, and the thickness of the porous insulating layer is 3 μm.

9. The lithium ion secondary battery according to claim 1, wherein the lithium nickel composite oxide is Li_{α}Ni_{β}Co_{γ}Mn_{δ}O₂, wherein 1≤α≤1.2, β+γ+δ=1, β≤0.7, and γ≤0.2.

10. The lithium ion secondary battery according to claim 1, wherein the lithium nickel composite oxide is Li_{α}Ni_{β}Co_{γ}Al_{δ}O₂, wherein 1≤α≤1.2, β+γ+δ=1, β≤0.7, and γ≤0.2.

11. The lithium ion secondary battery according to claim 1, wherein the lithium nickel composite oxide is LiNi_{β}Co_{γ}Mn_{δ}O₂, wherein 0.75≤β0.85, 0.05≤γ≤0.15, and 0.10≤δ≤0.20.

12. The lithium ion secondary battery according to claim 1, wherein the lithium nickel composite oxide is Li_{α}Ni_{β}Co_{γ}Mn_{δ}O₂, wherein 1≤α≤1.2, β+γ+δ=1, β≤0.7, and 0<γ≤0.2.

13. The lithium ion secondary battery according to claim 1, wherein the lithium nickel composite oxide is Li_{α}Ni_{β}Co_{γ}Al_{δ}O₂, wherein 1≤α≤1.2, β+γ+δ=1, β≤0.7, and 0<γ≤0.2.

14. A method for manufacturing a lithium ion secondary battery, the method comprising:
preparing a positive electrode, which has a current collector, a positive electrode active material layer and a porous insulating layer, a negative electrode, and a separator,
producing a stacked assembly by arranging the positive and negative electrodes to face each other with the separator interposed therebetween,
placing the stacked assembly into an outer package, and injecting an electrolyte solution so that the positive and negative electrodes can be impregnated with the electrolyte solution, and
sealing an opening of the outer package is,
wherein the separator is a single layer and is not melted or softened at least 200° C., a thermal shrinkage ratio of the separator being 3% or below,
wherein the porous insulating layer contains inorganic particles and a binder, and is formed on an entire of a surface of the positive electrode, the surface facing to the separator,
wherein the positive electrode is obtained by applying a porous insulating layer composition containing the inorganic particles and the binder directly onto the surface of the positive electrode, and the porous insulating layer composition is not applied on a surface of the separator,
wherein the porous insulating layer has a uniform thickness of the entire porous insulating layer that includes pores, and a thickness of the porous insulating layer is 1 μm or more and less than 10 μm,
wherein the inorganic particles are aluminum oxide,
wherein the binder is polyvinylidene fluoride (PVdF), and
wherein the positive electrode active material layer includes a lithium nickel composite oxide as a positive electrode active material, and the lithium nickel composite oxide is represented by formula (A),
Li_{y}Ni₍₁₋ₓ₎MₓO₂ (A),
wherein, in formula (A), 0<x<0.5, 0<y≤1.2, and M is at least one element selected from the group consisting of Co, Al, Mn, Fe, Ti and B.
